(19) United States
(12) Patent Application Publication
(10) Pub. No.: US 2015/0196879 A1
(43) Pub. Date: Jul. 16, 2015

(54) POROUS METAL MEMBRANE PRODUCED BY MEANS OF NOBLE GAS ION BOMBARDMENT

(71) Applicants: Helmholtz-Zentrum Dresden-Rossendorf E.V., Deutschland (DE); 13 Membrane GmbH, Dresden (DE)

(72) Inventors: Stephan Brinke-Seiferth, Hamburg (DE); Andreas Kolitsch, Deutschland (DE); Anatoli Rogozin, Deutschland (DE)

(21) Appl. No.: 14/411,623

(22) PCT Filed: Jun. 28, 2013
(86) PCT No.: PCT/EP2013/063670

§ 371 Date: Dec. 29, 2014

(30) Foreign Application Priority Data
Jun. 29, 2012 (DE) 10 2012 105 770.2

(51) Int. Cl. B01D 67/00; H01M 8/02; H01M 2/16; B01D 71/02

(52) U.S. Cl. CPC B01D 67/006; B01D 71/022; H01M 8/0291; H01M 2/1646; B01D 2323/00

(57) ABSTRACT

A process for producing a porous metal membrane (pore size 10 nm and 1 um), a metal membrane of this type, the use of the metal membrane and also corresponding filter modules. The Dice is 1-20 microns. The plasma immersion ion implantation process is utilized by bombarding a very thin metal foil with noble gas ions accelerated by means of a first accelerating voltage, in particular from both sides. The ion current is selected so that supersaturation occurs in the metal foil. Pores, in particular under the metal surface, are then formed by bubble segregation after supersaturation. Opening of the pores formed under the metal surface by ion implantation is effected by atomization of the surface by means of bombardment with noble gas ions using a second accelerating voltage which is lower than the first accelerating voltage.

### BACKGROUND OF THE INVENTION

1. Technical Field

The present invention relates to a method for producing a porous metal membrane, a metal membrane of this type, the use of the metal membrane, as well as corresponding filter modules.

### BACKGROUND INFORMATION

Polymer membranes have long been known. They are produced as flat membranes or hollow fiber membranes, and have a more or less high porosity. The most frequently used membrane polymers are polysulfones, polyethersulfones, cellulose, polyamides, among others. Membrane structures are differentiated according to symmetrical and asymmetrical structures. The process for producing asymmetrical membranes is the so-called phase inversion process. In this process, an originally homogeneous polymer solution is subjected to a phase separation through temperature changes or by contacting with a non-solvent in liquid or vapor phase. After phase separation and formation of a porous structure, the non-solvent is removed by elution. This method of production is described, for example, in U.S. Pat. No. 4,629,563 (1986) or in U.S. Pat. No. 4,900,449 (1990). Optimizations of this method of producing polymer membranes are described in DE 10042119 A1.

Aside from the known advantages of such membranes, the use of which, as compared to cellulose membranes, has spread worldwide, these membranes have disadvantages. These include the relative thickness of the membranes, which stems mainly from the requisite support layer. Within this support layer, deposition processes or fouling processes may occur. In flat membranes made of polymers, the folding (pleating) of the membrane which, for reasons of efficiency, is done to increase the filter surface area per volume unit of a filter module, frequently results in imperfections, which stem from cracks from the bending process. To avoid or to reduce such imperfections, some membrane producers use a double-layered membrane, which results in losses in filtration performance. Polymer membranes exhibit different sensitivities to chemicals. Thus, membranes made of cellulose acetate are sensitive to strong fluctuations in pH value, polysulfone membranes, on the other hand, exhibit a high resistance to acids and lyes, but are sensitive to radical-forming substances such as, for example, chlorine compounds or hydrogen peroxide, and in many cases to organic solvents as well.

Another method for producing membranes is the bombardment of thin, non-porous polymer films with ions. In this so-called ion track method, the polymer material is damaged by the ion bombardment, and the resulting damage tracks may be widened in a subsequent etching process, and this then gives rise to corresponding channel pores. Since such channels are by nature spaced a certain distance from one another due to their funnel shaped configuration, the result is a membrane which has a lower porosity of only 25 to 30% as compared to the membranes produced using the phase inversion process. This method for producing porous films is known, for example, from DE 4103853 A1 and has been in use for several decades. Smaller or larger channels are formed depending on the length and type of etching process.

To obviate the disadvantage of the sensitivity of polymer membranes to particular substances such as, for example, organic solvents, these techniques have been expanded. The aim was to produce porous metal foils that are shown to be less sensitive to the filtering media. One method is known from DE 10164214 A1. In this method, a porous polymer film, known and described above, is first produced by way of ion bombardment and a subsequent etching process. In this way, a thin metal layer is produced, which is so thin that the pores in the metal layer caused by the ions and subsequent etching remain open. Subsequently, the open pores are passed through by a galvanically inactive liquid in a galvanic deposition process, thereby forming a thicker metal layer, the pores, however, remaining open. In a further step, the polymer layer is then removed. What remains is the porous metal foil. A similar method, utilizing etching processes, is known from DE 102010001504A1. In this method, a very thin micro-porous layer is obtained, in which the carrier material of a porous separating layer applied thereto is, again, removed by chemical processes (sacrificial layer). The disadvantage of this type of production of a metal membrane lies in the complexity and in the ultimately very low porosity of the membrane, since it contains only individual holes caused by the ion tracks which, moreover, are not immediately adjacent to one another. Another method for producing porous metal foils is the production of pores using laser technology. This method requires no additional chemical additives. Pores are drilled using a laser, as is described, for example, in DE 102007032231 A1. The advantage of this method lies in the fact that chemicals need not be used, and complex etching processes need not be utilized for the production. With this method, however, it is not possible to produce pores smaller than 1 μm, since the technology is limited by the wavelength of the laser light. Since most of the principally used membrane processes fall in the area of nanofiltration, ultrafiltration or microfiltration, a membrane produced by way of laser drilling may usually be used solely for pre-filtration.

Ceramics constitute another membrane material. These are produced via various process stages, ultimately by sintering of the material. Ceramic membranes are distinguished by a high stability with respect to pressure, and by a high chemical resistance to organic substances as well. For this reason, ceramic membranes are frequently used in the chemical industry. The production of ceramic membranes is distinguished by the use of numerous chemicals and a complex production process. Such a method is known from DE 60016093 T2. The disadvantage of such membranes is the lack of flexibility and the high fracture sensitivity, as well as a low flow rate. As in the case of conventional polymer membranes, ceramic membranes also have a thin separating layer situated on a support layer, which results in the described disadvantages. With great effort an attempt has been made to produce flexible structures by applying ceramic materials to nonwoven fabrics, as is described in DE 10208280A1. In this case, the bonding capacity of the ceramic material to the non-woven is an important factor and is influenced by additional chemical treatments.

The object is to produce a very thin, flexible and resistant membrane having a high strength. Here, complex production steps involving the sacrifice of support layers or by subsequent removal of an original membrane are to be dispensed with. The object is also to obtain a pore structure also between 10 nm and 1 μm and to be able to simply configure these as desired, and to be independent of the diameter of ion tracks and their etching or of laser beams. The porosity in this case should be so high that it is clearly superior to the ion track process. In addition, the use of chemicals is to be dispensed with to the extent possible.

To achieve the object, a method is utilized, the essential features of which are known and modified from the treatment of metal surfaces. In this method, gas ions are shot into a metal surface (for example, titanium) and, in the process, the ions are implanted in the surface. These remain in the material and result, for example, in an increased resistance to oxidation, as described in DE102006043436B3. The implantation takes place using the so-called plasma-immersion ion implantation (PIII).

Another example of the treatment of metal surfaces with gas ions is known from US 2008/0145400 A1. In this case, medical endoprostheses are treated with the plasma-immersion ion implantation process. Through the implantation of noble gases, such as argon or helium, the surfaces of, for example, stents are structured in the nano-range to micrometer range, and the stents are used as storage for medicinal active ingredients. The aim of such “drug eluting stents” is the reduction of rejection reactions of the human body through direct administration of medications through the stent itself.

### SUMMARY

According to the present invention, the plasma-immersion ion implantation process is now used in such a way that a very thin foil made of metal, such as aluminum, titanium, gold, preferably however, stainless steel, having a thickness of up to 20 μm, preferably between 1 μm and 10 μm, is bombarded with noble gas ions such as helium, argon, krypton, preferably however, helium and/or argon, by means of a first accelerating voltage, in particular, from both sides. The ion current in this case is selected so that supersaturation occurs in the metal foil. Pores are then formed, in particular under the metal surface, by bubble segregation after supersaturation. Depending on the ion current, which may be controlled by the concentration and type of gas, as well as per set temperature, set operating pressure, first acceleration voltage and period of exposure, smaller or larger pores form, the distribution of which may also be controlled as a function of the aforementioned parameters (temperature, voltage, ion concentration, time, pressure). Thus, the pore-forming process depends in part on the concentration of the gas ions and in part also on temporal and thermal conditions. The so-called bubble segregation is comparable to Ostwald ripening: the tiniest bubbles unite to form small bubbles, small bubbles unite to form medium-size bubbles, medium-size bubbles unite to form large bubbles, etc. as a function of time subject to temperature. The result in such case is also invariably a Gaussian distribution of pore sizes. The advantage of such a distribution is the high porosity, which is comparable to that of polymer membranes produced via phase separation, although the production process is completely different.

The ion dose is advantageously from 5E16 up to 1E18 ions/cm², in particular, within a period of up to 10 hours, in particular, of 1 minute to 10 hours.

The opening of the pores formed under the metal surface by ion implantation occurs as a result of atomization of the surface by means of bombardment with noble gas ions using a second accelerating voltage that is lower than the first accelerating voltage. This is advantageously achieved by lowering the acceleration voltage to a second acceleration voltage, in particular, to an optimal atomization rate for the particular metal, and by the corresponding ion(s) and production of additional plasma. In this way, pores may be opened outwardly or to other pores and porous passages through the metal foil may be produced. The second acceleration voltage for sputtering lies generally between 800 and 5000V. The acceleration voltage in this case is advantageously lowered from the first to the second acceleration voltage in one stage. The lowering occurs advantageously without interruption, or only with an interruption duration of less than 1 minute, in particular 10 seconds, of the bombardment with noble gas ions. The bombardment with the second acceleration voltage is advantageously pulsed, advantageously with the same pulse durations and pulse pauses as specified for the bombardment with the first acceleration voltage.

A metal foil made of stainless steel, for example, is bombarded for between 10 minutes and several hours at temperatures up to 650° C. and at a helium ion dose from 5E16 up to 1E18 ions/cm².

Here, the pore distribution, as a result of the choice of aforementioned parameters, may be so finely adjusted according to the invention, for example, between 0.1 μm and 0.4 μm, that, for example, the metal membrane thus produced may be used for oil-water separation even of hot waters.

The advantage of the membrane according to the invention is that the membrane according to the invention is thinner than the membranes known from the prior art, and that thermal resistance is much greater than in the materials used in the prior art. Moreover, metal foils may be produced with a significantly higher porosity. According to the invention, this may be 50% to 70% or more.

Due to its properties, a metal membrane produced according to the invention may be used in numerous fields. Because no carrier material is used in the production process, in contrast to frequently used polymer membranes, the separating layer itself constitutes the membrane, which increases the throughput significantly. Thus, in contrast to a polymer membrane, many times the surface area may be accommodated in a module of the same size as a result of pleating. During the pleating process, the metal membrane has the advantage that the latter is flexible due to the natural properties of metals and, therefore, no cracks form at the pleated points. Moreover, metal is a substance, which is far more inert and temperature-resistant than polymers. In addition, metal possesses an excellent tensile stability as well as a defined durability. Thus, a metal membrane according to the invention may be advantageously used at high pressure or at high temperatures.

A membrane according to the invention may, for example, be used for filtering or separating solutions, suspensions, emulsions, foams, aerosols, gaseous mixtures, smoke, dust, vapors or mists.

In the area of microfiltration (average pore diameter of 0.1 μm to 0.4 μm), applications for sterile filtration are also possible using the membrane according to the invention. Sterile filters for the defined sterilization of water are needed, in particular, for producing pharmaceutical products or in the medical technology field. Due to the inert properties of the membrane according to the invention, it is possible in the area of microfiltration to also filter solvents such as, for example, alcohol, for the defined removal of spores, for example.

In the area of microfiltration (average pore diameter 0.1 μm to 0.4 μm), the use as a membrane inside batteries is possible, in particular, due to the minimal thickness and as well as due to the defined thermal resistance of the material used for the membrane according to the invention. Thus, the membrane could be used as an ion conductor in lithium batteries for separating the anode from the cathode. With respect to the resistance of the membrane according to the invention, a use thereof in fuel cells may also be characterized as advantageous.

In the area of ultrafiltration (average pore diameter between 0.01 μm to 0.1 μm), various uses in the areas of the separation of macromolecules, virus filtration, but also in bioreactors for the defined release of macromolecules may be specified, in which the membrane according to the invention may be used. The advantage here is the possibility of sterilizing the membrane with steam, which is unproblematic due to its material properties.

In the area of nanofiltration (average pore diameter of 0.01 μm to 0.001 μm), the membranes produced according to the invention may be used, for example, for separating salts during the production of antibiotics. Also conceivable is the use, for example, for the purpose of the decolorization of liquids in the beverage industry. Here, too, there is the advantage of thermal resistance in terms of the requisite cleaning of the membranes, but also the use of higher temperatures during the filtration process itself, with the membrane according to the invention is advantageous.

The method is advantageously carried out in a closed chamber.

The atmosphere in which the PIII method is carried out may be advantageously formed from one or multiple noble gases. The pressure immediately prior to the start of the PIII method is advantageously 10⁻³-10⁻² Pa. During the process, it advantageously increases to 0.1 to 20 Pa.

For purposes of production, an antenna is advantageously used within the atmosphere, by means of which a plasma is produced. The frequency with which the antenna is supplied is advantageously from 8 to 20 MHz, typically 13 to 15 MHz, although frequencies of 100 kHz to 2.45 GHz are also possible.

The power with which the antenna is supplied is advantageously between 100 and 1000 W, in particular between 300 W and 400 W. The first acceleration voltage is advantageously between 10 and 50 kV, in particular, between 20 and 40 kV. The pulse duration of the acceleration voltage is advantageously 5 to 50 μs. Shorter durations of 5 to 10 μs are preferable in this case. The pulse frequencies run advantageously in the range of 100 Hz to 2 kHz. The advantageous pulse count lies between 500,000 and 2,000,000. During each pulse, a particular ion dose is implanted. The dose per pulse is advantageously 1×10¹⁰ ions/cm² to 1×10¹² ions/cm², in particular 5×10¹⁰ ions/cm² to 5×10¹⁵ ions/cm².

The bombardment of the metal foil with the first acceleration voltage advantageously takes place from both sides of the metal foil, in particular, at thicknesses of the metal foil greater than 10 μm, in particular 5 μm, and more. In this case, the bombardment takes place from both sides simultaneously or in succession, advantageously however, from both sides simultaneously. For the simultaneous bombardment of both sides, the metal foil is provided, in particular, completely in the plasma and/or the first acceleration voltage is applied from both sides of the metal foil, so that ions are accelerated from both sides onto the metal foil. If the sides are bombarded in succession, implantation of both sides of the foil takes place in succession in a two-stage process.

Advantageously, the bombardment with the second acceleration voltage also takes place on both sides, in particular, from both sides simultaneously.

The bombardment on both sides results in a more uniform and more rapid formation of the structures according to the invention.

The substrate temperature of the metal foil during the bombardment with the first acceleration voltage is generally between 100° C. and 750° C. In this case, higher temperatures also result in a greater penetration depth of the ions, since the influence of the solid body diffusion also takes effect. In principle, the substrate temperature may be adjusted and varied for each process. A beam intensity of 10 μA/cm² at a voltage of 50 kV and an output of 0.5 W/cm² is sufficient, for example, to heat the substrate to 250° C. The temperature may be controlled, in particular, by varying the pulse frequency. For higher temperatures, an additional heating of the foils is foreseeable. At a voltage of 20 kV, the frequency should be no higher than 1.5 kHz. At a voltage of just 10 kV, frequencies up to 3.5 kHz are preferred.

### BRIEF DESCRIPTION OF THE DRAWINGS

Additional advantages and possible embodiments are presented by way of example and are not limiting, according to the following description of an example with reference to purely schematic figures. In the figures:

FIG. 1 shows a scanning electron microscope image of a stainless steel foil having a thickness of 5 μm after argon ion implantation on both sides at an ion dose of 1.5E15/cm² and atomization, and

FIG. 2 shows a scanning electron microscope image of the stainless steel foil from FIG. 1 in cross-section.

### DETAILED DESCRIPTION

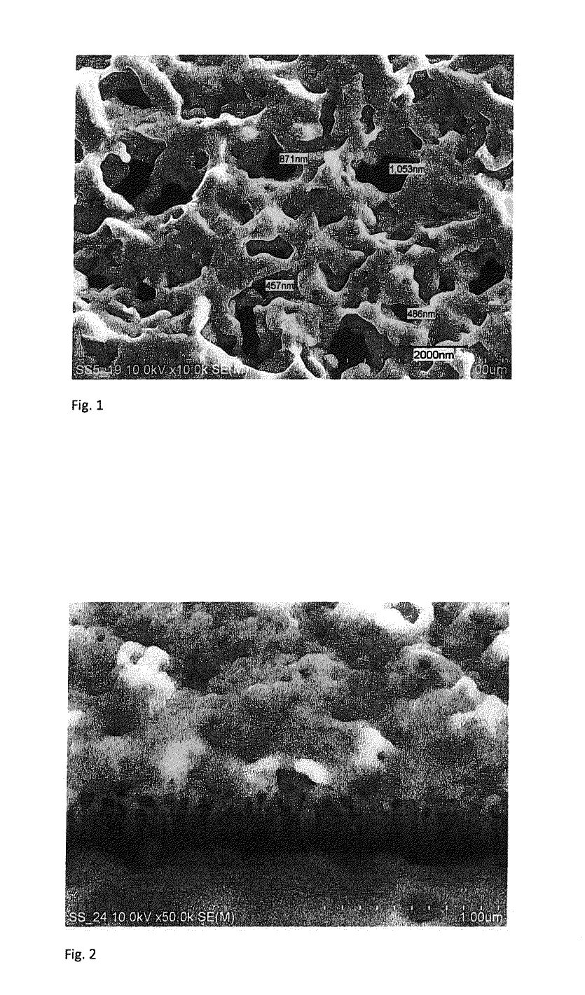

FIG. 1 shows a scanning electron microscope image of a stainless steel foil having a thickness of 5 μm after argon ion implantation at an ion dose of 1.5E15/cm² and atomization by sputtering. An inductively coupled plasma was produced at a frequency of 13.56 MHz using a water-cooled quartz antenna in a vacuum chamber, filled previously with argon at 0.5 Pa. The power coupled into the antenna was 400 W. As pulse voltage for the plasma-immersion ion implantation, 25 kV with a pulse duration of 10 μs and at a frequency of 2 kHz was negatively applied to the metal foil. An ion dose of 1.5E15/cm² was implanted. The surface temperature of the stainless steel foil was monitored with an infrared camera. The temperature was 580° C. The acceleration voltage was subsequently lowered and the foil sputtered at an acceleration voltage of 2 kV. Pore sizes of 0.4 μm to 1 μm were identified and marked in the scanning electron microscope image.

FIG. 2 shows a scanning electron microscope image of a cross-section of the stainless steel foil from FIG. 1.

1. A method for producing a porous metal membrane, comprising the following steps:
a. providing a metal foil having a thickness of up to 20 μm in an atmosphere containing at least one noble gas;
b. producing a plasma containing ions of the at least one noble gas;
c. bombarding the metal foil with noble gas ions by applying a first acceleration voltage; and
d. subsequent bombardment of the metal foil with noble gas ions at a second acceleration voltage that is lower than the first acceleration voltage.

2. The method according to claim 1, wherein the first acceleration voltage is between 10 kV and 50 kV.

3. The method according to claim 1, wherein the second acceleration voltage is between 0.8 kV and 5 kV.

4. The method according to claim 1, wherein the bombarding with the first or second acceleration voltage is pulsed.

5. The method according to claim 1, wherein the metal foil has a thickness of 1 μm or more.

6. The method according to claim 1, wherein the bombarding with the first or second acceleration voltage occurs on both sides of the metal foil.

7. The method according to claim 1, wherein the atmosphere consists of noble gas.

8. The method according to claim 1, wherein the plasma is produced by applying an AC voltage to an antenna within the atmosphere.

9. A method for filtering, comprising the following steps:
a. producing at least one porous metal membrane according to claim 1; and
b. filtering a liquid or gaseous mixture while the mixture passes through the at least one metal filter membrane, with at least one substance being precipitated from the mixture.

10. A porous metal membrane having a thickness of up to 20 μm, wherein this membrane includes porous passages, which have a pore diameter of between 1 nm and 1 μm.

11. A filter module containing at least one porous metal membrane according to claim 10.

12. A use of a porous metal membrane according to claim 10 for filtering or separating solutions, suspensions, emulsions, foams, aerosols, gaseous mixtures, smoke, dust, vapors or mists, or as a membrane in a storage for electrical energy or a fuel cell.

13. The method according to claim 6, wherein the bombarding with the first or second acceleration voltage occurs simultaneously from both sides of the metal foil.

14. The porous metal membrane according to claim 10, wherein the membrane has a thickness of 1 μm or more.

15. A filter module containing at least one porous metal produced according to claim 1 for filtering or separating solutions, suspensions, emulsions, foams, aerosols, gaseous mixtures, smoke, dust, vapors or mists, or as a membrane in a storage for electrical energy or a fuel cell.

16. A use of a porous metal membrane produced according to claim 1 for filtering or separating solutions, suspensions, emulsions, foams, aerosols, gaseous mixtures, smoke, dust, vapors or mists, or as a membrane in a storage for electrical energy or a fuel cell.
